(19) United States
(12) Patent Application Publication
(10) Pub. No.: US 2012/0330451 A1
(43) Pub. Date: Dec. 27, 2012

(54) CONTROL SYSTEMS AND METHODS FOR MATERIAL PROCESSING

(76) Inventors: Martin C. Dillner, Valencia, PA (US); Brian Frisk, Ellwood City, PA (US)

(21) Appl. No.: 13/166,687

(22) Filed: Jun. 22, 2011

(51) Int. Cl. G05D 17/02

(52) U.S. Cl. 700/103

(57) ABSTRACT

Various embodiments are directed to methods of controlling torque delivered to a device for working material, the methods may comprise receiving, by a computer, a first value indicating an actual torque delivered by a common motor of the device to at least a portion of a plurality of work rolls of the device. The plurality of work rolls may be driven by the common motor, and may be arranged along a line direction aligned with an entry end. The methods may also comprise setting, by the computer, a torque limit for the common motor equal to the first value plus a torque limit increment for an additional work roll selected from the plurality of work rolls.

### BACKGROUND

Various rolling devices are used to process sheet metal and other materials. For example, rolling mills are used to shape material. Rolling mills typically include a set of two or more work rolls. Material stock is provided between the work rolls. Pressure provided to the material by the work rolls causes the material to confirm to a desired shape, typically a continuous web. In addition to rolling mills, there are many downstream processes that include equipment, such as levelers. Levelers are used to correct various defects that often remain in sheet or web material after rolling. Such defects may include, for example, coil set, cross-bow, center buckle, edge wave, etc. A leveler typically comprises top and bottom work rolls offset from one another such that the processed material is bent to some degree around the successive work rolls, with work rolls above the material bending it in one direction and work rolls below the material bending it in the opposite direction. In this way, the leveler works the material to remove the defects.

### FIGURES

Various embodiments of the present invention are described here by way of example in conjunction with the following figures, wherein:

FIG. 1 illustrates one embodiment of a leveler that may be utilized with the torque control methods and systems described herein.

FIG. 2 illustrates a top view of one embodiment of the leveler of FIG. 1.

FIG. 3 illustrates a side view of one embodiment the leveler of FIG. 1.

FIG. 4 illustrates a block diagram of one embodiment of a leveler with a torque control feature.

FIG. 5 is a diagram of a process flow illustrating one embodiment of the operation of the control circuit of FIG. 4 to regulate the leveler of FIG. 4.

FIG. 6 is a diagram of a process flow illustrating one embodiment of the operation of the control circuit of FIG. 4 to calculate a position of a material sheet based on signals from a proximity sensor, a speed sensor and an encoder.

FIG. 7 illustrates a block diagram of the leveler of FIG. 4 showing the material sheet as it progresses through the leveler.

FIG. 8 illustrates a block diagram of the leveler of FIG. 4 showing the material sheet with its trailing edge past the proximity sensor.

FIG. 9 illustrates a block diagram of one embodiment of the leveler of FIG. 4 showing unloaded work rolls as the trailing edge of the material sheet passes through the leveler.

FIG. 10 is a diagram of a process flow illustrating an alternate embodiment for modulating the torque delivered by the motor.

FIG. 11 is a diagram of a process flow illustrating another alternate embodiment for modulating the torque delivered by the motor.

FIG. 12 is a diagram of a process flow illustrating another embodiment for modulating the torque delivered by the motor.

### DESCRIPTION

Various embodiments are directed to material processing devices having torque-controlled work rolls. Although the examples described herein are provided in the context of a leveler, it will be appreciated that the torque-control methods described may be used in various other material processing devices including, for example, rollers or rolling mills, straighteners, etc. According to various embodiments, a leveler may comprise a plurality of work rolls arranged linearly above and below the material web or sheet along a line direction. All or a portion of the work rolls may be driven by a common motor. Drive train components (e.g., reducers, gearboxes, etc.) may couple the output of the common motor to each driven work roll.

In some embodiments, it may be desirable to operate, or allow for the operation of, the leveler with uneven load conditions (e.g., with not all of the work rolls in contact with material). This may occur, for example, as the leading edge of a sheet or web of material enters the leveler or as the trailing edge of a sheet or web of material exits the leveler. When the leveler is subjected to uneven load conditions, the drive train components may direct all or a substantial portion of the common motor's torque towards the loaded work rolls and away from unloaded work rolls. This may cause large mechanical stresses on the drive components and work rolls that are commonly loaded during uneven load conditions (e.g., those near the entry and exit ends of the leveler). For example, as material enters or exits the leveler there is a risk that the applied stresses will exceed the design limits of various drive train components. This risk may be more acute, for example, in levelers having larger numbers of work rolls, levelers applying a large quantity of work to the material, etc.

To allow for these stresses, various embodiments may comprise a control circuit in communication with the common motor and at least one sensor. Signals received from the at least one sensor, the control circuit may indicate a position of a sheet or web of material along the line direction relative to the work rolls. The control circuit may receive the signals from the at least one sensor and derive the position of the sheet or web. From the derived position, the control circuit may determine which work rolls of the leveler are loaded (e.g., which are in contact with the material). Based on this data, the control circuit may limit the torque produced by the common motor to prevent overstressing of work rolls and/or associated drive train components.

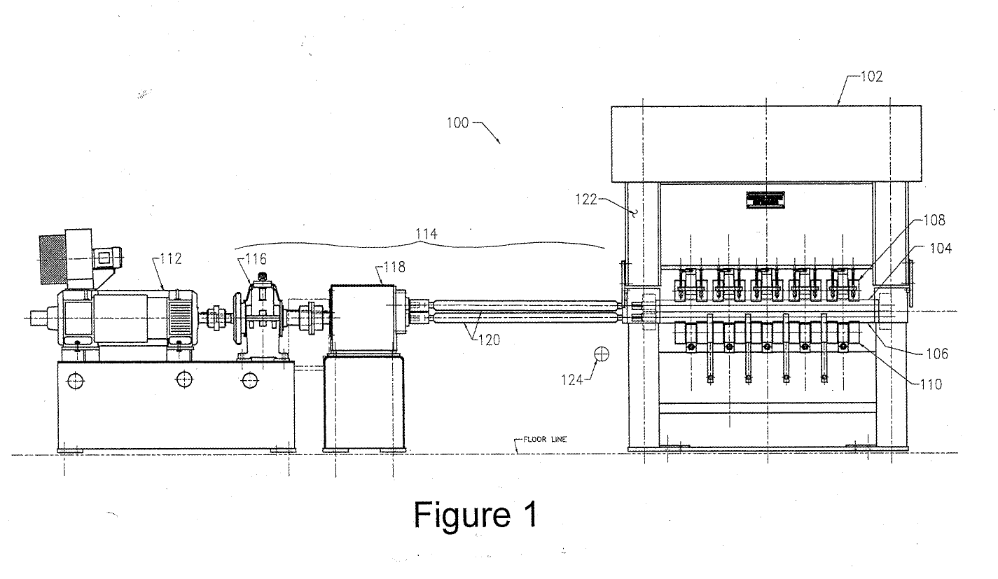

FIG. 1 illustrates one embodiment of a leveler 100 that may be utilized with the torque control methods and systems described herein. The leveler 100 may comprise a frame 102 that houses top work rolls 104 and bottom work rolls 106. The entry end 122 is shown in FIG. 1. For example, material entering the leveler 100 between the work rolls 104, 106 may enter in a direction indicated by arrow 124 pointing into the page in FIG. 1. In various embodiments, the leveler 100 may also comprise top and bottom back-up rolls 108, 110. The back-up rolls 108, 110 may be positioned above and below the respective top and bottom work rolls 104, 106. In various embodiments, the back-up rolls 108, 110 may be adjustable to allow differential pressure to be applied to material processed by the leveler. In embodiments utilizing other material processing devices (e.g., rolling mills, straighteners, etc.) the back-up rolls 108, 110 may not necessarily be adjustable and may, in some cases, be omitted.

The work rolls 104, 106 may be driven by a motor 112 mechanically coupled to the work rolls 104, 106 by a drive train 114. The motor 112 may be any suitable form of electric or other motor. For example, in various embodiments, the motor 112 may be a direct current (D/C) and/or alternative current (A/C) motor. In some embodiments, non-electric motors such as, for example, internal combustion motors, hydraulic motors, pneumatic motors, etc., may be used. The power, rotations-per-minute (RPM) and other properties of the motor 112 may be selected based on the requirements of each individual machine. For example, according to various embodiments, the motor 112 may provide between 5 horsepower (HP) and 500 HP. In some embodiments, the motor 112 may comprise multiple motors. The speed of rotation of the motor 112 may be fast or slow, depending on the specific application. For example, various embodiments, the motor may operate at between 850 and 1700 rotations-per-minute (RPM).

The drive train 114 may comprise any suitable mechanical device and/or combination of mechanical devices for coupling the motor 112 to the work rolls 104, 106. In the example embodiment shown in FIG. 1, the drive train 114 may comprise a reducer 116, a gearbox 118 and a plurality of drive spindles 120. The reducer 116 may reduce the rotational speed of the motor 112. For example, the motor may rotate at a speed much exceeding the desired rotational speed of the work rolls 104, 106. The reducer 116, alone or in conjunction with the gearbox 118, may reduce the rotational speed of the motor 112 to the desired rotational speed of the work rolls 104, 106. The gear box 118 may comprise any combination of components for coupling the output of the reducer 116 (or the motor 112 in embodiments omitting the reducer 116) to the drive spindles 120. According to various embodiments, the reducer 116 and the gear box 118 may comprise mechanical gears and/or hydraulic or any other type of components.

The gear box 118 may comprise a plurality of mechanical outputs. Each output may be coupled to one of the drive spindles 120. Each drive spindle 120 may be, directly or indirectly coupled mechanically to one of the work rolls 104, 106 to cause rotation thereof. It will be appreciated that the drive train 114 illustrated in FIG. 1 is just one example of a drive train that may be used and that any suitable components or combination of components may be used to mechanically couple the motor 112 to the work rolls 104, 106.

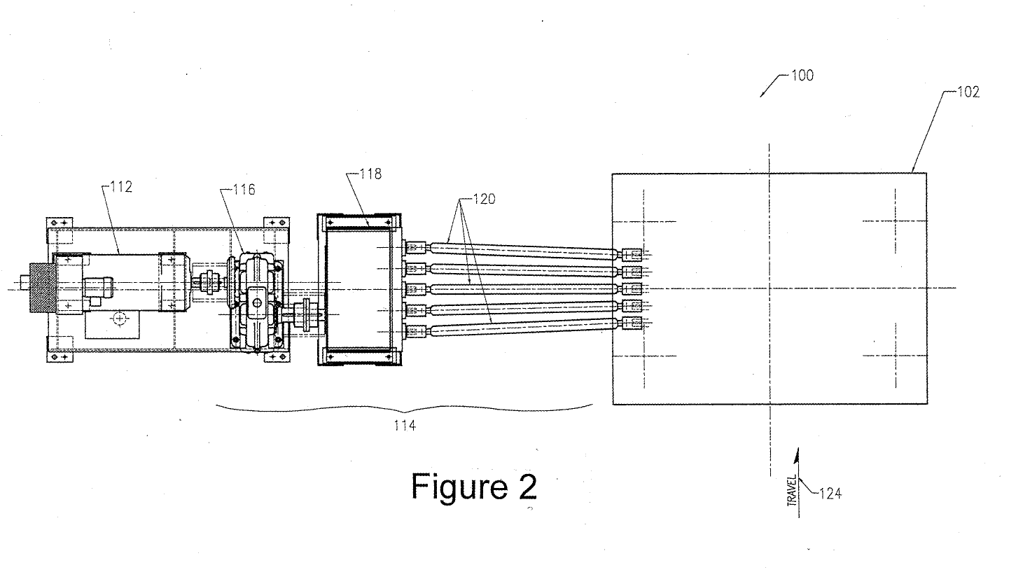

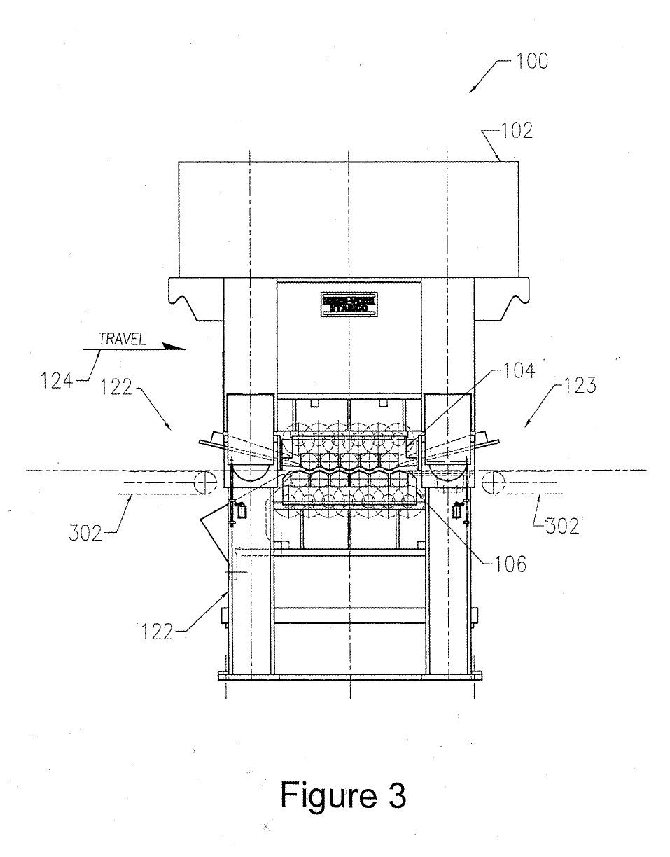

FIG. 2 illustrates a top view of one embodiment of the leveler 100. Arrow 124, indicating the line direction, is shown to point up. FIG. 3 illustrates a side view of one embodiment the leveler 100. As illustrated in FIG. 3, the drive motor 112 and drive train 114 may be obscured by frame 102. FIG. 3 also illustrates a conveyor 302 that may be used to provide material to the entry end 122 of the leveler 100 and receive worked material from the exit end 123 of the leveler 100. The conveyer 302 may be any suitable device for transporting material to be worked including, for example, a belt conveyor, a roller conveyor, etc. In some embodiments, the conveyor 302 may be omitted. For example, in embodiments where the material is in web form, it may not be necessary to include a conveyor.

The degree to which the work rolls 104, 106 work material may be determined, for example, based on the thickness of the material (thicker material may require more work) and the distance between the upper work rolls 104 and the lower work rolls 106 (less distance may cause the leveler 100 to work the material harder). According to various embodiments, the top work rolls 104 may be at a common height, or the height of one or more of the top work rolls 104 may be offset up or down. Similarly, the bottom work rolls 106 may be at a common height, or some of the bottom work rolls 106 may be offset up or down. For example, work rolls 104, 106 at the entry end may be offset away from the material relative to other work rolls 104, 106 in the leveler 100. The material processed by the leveler 100 may be any sort of material (e.g., in sheet or web form) that may be worked by the work rolls 104, 106 to manage and/or modify material properties. For example, in various embodiments, the material may be metal, plastic, etc. Example metal materials may include carbon steel, stainless steel, copper, brass, aluminum, titanium, etc.

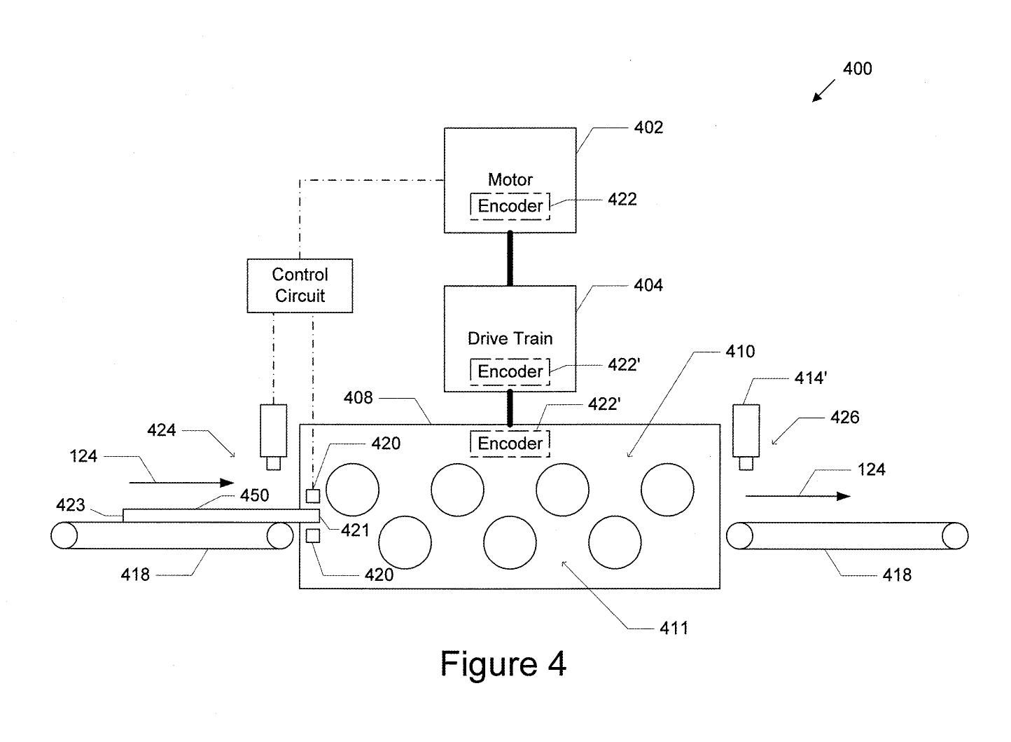

FIG. 4 illustrates a block diagram of one embodiment of a leveler 400 with a torque control feature. The leveler 400 may comprise a motor 402, drive train 404, frame 408 and work rolls (top work rolls 410 and bottom work rolls 411), for example, similar to those described above. In addition, the leveler 400 may comprise a control circuit 412 in communication with one or more sensors 414, 420, 422 for determining a position of material. As illustrated in FIG. 4, a sheet of material 450 is provided at an entry end 424 of the leveler 400 along the line direction 124 by a conveyor 416. Although the material 450 is illustrated as a sheet, it will be appreciated that similar considerations, and similar control equipment and methodologies, may be utilized for web material. For example, the leading and trailing edges of a material web may be handled in a manner similar to the leading and trailing edges of the sheet 450, as described herein.

According to various embodiments, the control circuit 412 may modify the operating properties of the motor 402 to regulate the torque delivered to the work rolls 410, 411, for example, based on the number of work rolls 410, 411 that are loaded at any given time. The control circuit 412 may be any suitable type of analog or digital circuit. In various embodiments, the control circuit 412 may be and/or comprise a computer or related device. For example, in various embodiments, the control circuit 412 may comprise a programmable logic controller (PLC) available from any manufacturer of suitable devices including, for example, SIEMENS, GENERAL ELECTRIC, MITSUBISHI ELECTRIC, ALLEN-BRADLEY, OMRON, etc.

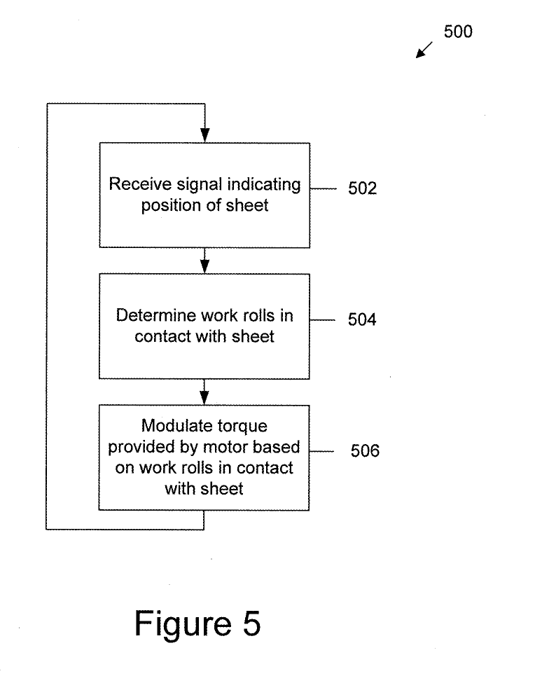

FIG. 5 is a diagram of a process flow 500 illustrating one embodiment of the operation of the control circuit 412 to regulate the leveler 400. At 502, the control circuit 412 may receive one or more signals from one or more of the sensors 414, 420, 422 indicating a position of the material sheet 450. The control circuit 412 may derive a position of the sheet 450 relative to the work rolls 410, 411 based on the one or more signals. At 504, the control circuit 412 may determine work rolls 410, 411 in contact with the material sheet 450 (e.g., loaded) based on the position of the material sheet 450. For example, the control circuit 412 may determine which particular work rolls 410, 411 are loaded, or may generally derive a number of work rolls 410, 411 that are loaded. At 506, the control circuit 412 may modulate the torque provided to the work rolls 410, 411 by the motor 402, for example, based on the number of work rolls 410, 411 in contact with the material sheet 450. The control circuit 412 may modulate the torque in any suitable way. For example, the control circuit 412 may modulate a current and/or voltage delivered to the motor 402 in order to regulate torque. Also, in some embodiments, the motor 402 may be implemented with a drive system. The type of drive system used may depend on the motor. For example, in embodiments utilizing a single AC motor, an AC drive may be used, such as, for example, the COMMANDER or UNIDRIVE lines available from EMERSON INDUSTRIAL AUTOMATION, the POWERFLEX AC line available from ALLEN-BRADLEY, or any other AC drive. When a DC motor is used, an appropriate DC drive may be used such as, for example, the MENTOR and/or QUANTUM series lines available from EMERSON INDUSTRIAL AUTOMATION, the POWERFLEX DC line available from ALLEN-BRADLEY, etc. In embodiments where a drive system is used, the control circuit 412, may provide a signal to the drive system indicating a desired torque limit for the motor 402. The drive system may, in turn, modulate the operation of the motor to avoid exceeding the desired torque limit. In various embodiments, instead of or in addition to the motor drive, the leveler 400 may be implemented with a torque-sensing coupler or other torque sensing device. The control circuit 412 may receive a signal from the torque-sensing coupling indicating a torque delivered by the motor 402 and may modulate a current, voltage, or other control parameter of the motor in order to keep the torque from exceeding the desired torque limit. In some embodiments, similar torque-sensing devices may be placed to sense torque delivered to one or more of the work rolls 410, 411. An example torque-sensing coupler that may be used is the MONITORQ torque monitoring system available from AUTOGARD.

The control circuit 412 may select an appropriate torque limit for the motor 402 based on any suitable method or criteria. For example, according to various embodiments, the control circuit 412 may store a per-work roll torque allowance for the work rolls 410, 411. After determining the number of work rolls 410, 411 that are loaded, the control circuit 412 may multiply the per-work roll torque allowance for the work rolls by the number of loaded work rolls to determine a torque allowance for the leveler 400 in its current state. The motor 402 may be modulated based on the leveler torque allowance. In various embodiments, some or all of the work rolls 410, 411 may have an individualized torque allowance. For example, different work rolls 410, 411 and/or associated drive train components may be constructed to different allowances. In some embodiments, work rolls 410, 411 near the entry end 424 of the leveler may be constructed with a higher torque allowance than other rolls. In these embodiments, the control circuit 412 may, for example, use a common per-work roll torque allowance that considers all of the torque allowances of the different work rolls 410, 411. Also, in various embodiments, the control circuit 412 may, as described above, determine the identity of particular work rolls 410, 411 that are in contact with the material sheet 450 at any given time. The control circuit 412 may then sum the individual torque allowances for each loaded work roll 410, 411, resulting in a leveler torque allowance that may be used to modulate the torque delivered by the motor 402.

It will be appreciated that any suitable sensor or combination of sensors may be used by the control circuit 412 to track the position of the material sheet 450. For example, a series of proximity sensors 420, 423 (e.g., optical, sonic, etc.) may be placed throughout the leveler 400 along the line direction 124. Each of the proximity sensors 420, 423 may have a location along the line direction 124 that is known to the control circuit 412 and may transmit to the control circuit 412 a signal either indicating that the material sheet 450 is present, or that it is not present. The control circuit 412 may determine a position of the material sheet 450 based on which sensors 420 indicate the presence of the material sheet 450 and the known locations of the sensors 420.

According to various embodiments, the control circuit 412 may determine the position of the material sheet 450 based on a combination of speed sensors indicating a speed of the material sheet 450 and position sensors indicating a position of the material sheet 450. For example, as illustrated in FIG. 4, a material speed sensor 414 may sense the speed of the material sheet 450 at or near the entry end 424 of the leveler 400. The material speed sensor 414 may be any suitable sensor or sensor type. For example, in various embodiments, the material speed sensor 414 may be a Doppler velocimeter sensor such as, for example, the SM3 LASER-DOPPLER VELOCIMETER available from APPLIED UNIVERSITY RESEARCH INC., the BETA LASERMIKE LASERSPEED GAUGE available from BETA LASERMIKE, the LSV series of laser surface velocimeters available from POLYTEC, various instruments available from KANOMAX, etc. The material speed sensor 414 may be positioned at about the entry end 424 of the leveler 400. The material sheet 450 may be within a field of view of the material speed sensor 414, either from above, as shown in FIG. 4, or from below. In the embodiment shown in FIG. 4, the material speed sensor 414 is directed down towards the material sheet 450 and the conveyor 416. In various embodiments, the material speed sensor 414 may be or comprise a contact measuring wheel, another laser-based speed sensor, etc. According to various embodiments, the distance along the line direction 124 between the material speed sensor 414 and the first work roll 410, 411 may determine the minimum sheet length that may be worked by the leveler 400. For example, if a material sheet 450 does not reach the work rolls 410, 411 before its trailing edge 423 passes the material speed sensor 414, it may be very difficult to track the material sheet 450.

A leading edge sensor 420 may be used to sense a leading edge 421 of the material sheet 450. The leading edge sensor 420 may be a proximity sensor having a fixed location known to the control circuit 412. When the leading edge 421 of the material sheet 450 passes the location of the leading edge sensor 420, a signal from the leading edge sensor 420 to the control circuit 412 may change state, indicating the presence of the leading edge 421 at the known location of the sensor 420. The leading edge sensor 420 may be any suitable type of single-sided or double-sided proximity sensor. For example, the leading edge sensor 420 may be or comprise a thru-beam eye configured to pass a beam across the line direction 124. The sensor 420 may produce a signal or a change in a signal based when the beam is broken. Also, for example, the sensor 420 may be or comprise a photoswitch (e.g., diffuse, laser, reflective, etc.), a mechanical limit switch, an inductive or capacitive proximity switch. In various embodiments (e.g., embodiments without an intake conveyor 416), the leading edge sensor 420 may be replaced by a “material present” output from the material speed sensor 414. It will be appreciated that in some embodiments, such as those utilizing an intake conveyor 416, the material speed sensor 414 may provide a reading regardless of the presence or absence of the material sheet 450. For example, when the material sheet 450 is absent, the material speed sensor 414 may provide a reading indicating a speed of the conveyor 416.

According to various embodiments, after a trailing edge 423 of the material sheet 450 passes the position of the material speed sensor 414 along the line direction 424, the material speed sensor 414 may not provide additional indications of the speed of the material sheet 450. Accordingly, an additional speed sensor or speed sensors may be included in the leveler 400. For example, a second speed sensor 414′ may be positioned near the exit end 426 of the leveler and may measure the speed of the material sheet 450 as it exists the leveler 400. The second speed sensor 414′ may operate in a manner similar to that of the sensor 414, as described above. It will be appreciated that, even with two sensors 414, 414′, the leveler 400 may not be able to completely track sheets 450 having a length less than the distance between the sensors 414, 414′.

In some embodiments, a motor encoder 422 may be utilized to supplement the one or more speed sensors 414, 414′. The motor encoder 422 may be positioned to measure the movement of the work rolls 410, 411 indirectly by measuring the position and/or angular speed of the motor 402. From the encoder signal, the control circuit 412 may derive a position and/or rotation speed of the work rolls 410, 411, for example, given a gear ratio of the drive train 404. In some, but not all, embodiments, all of the work rolls 410, 411 may be driven at a constant speed. Although the encoder 422 is described as being positioned to measure a position and/or angular speed of the motor 402, it will be appreciated that various embodiments may utilize encoders 422′ at different locations in addition to or instead of the motor encoder 422. Encoders 422′ may be positioned, for example, anywhere in the drive train 404, at the leveler 400, etc. For example, one or more of the encoders 422′ may be positioned to directly sense the rotation of one or more of the work rolls 410, 411. The encoders 422, 422′ may be or comprise any suitable type of sensor for sensing movement including, for example, an optical encoder, a mechanical encoder, a rotary encoder, a linear encoder, an analog tachometer, etc.

The control circuit 412 may derive a speed of the material sheet 450 from the output of the motor encoders 422. The instant example is described utilizing a single motor encoder 422. It will be appreciated that different encoders 422′ at different positions in the leveler 400 may be used in addition or instead of the motor encoder 422. When the motor 402 is in operation, the encoder 422 may provide a signal indicating a speed of rotation of the motor. The control circuit 412 may convert this speed to a rotation speed of the work rolls 410, 411, for example, based upon the gear ratio of the drive train 404. The control circuit 412 may also derive a linear displacement of the material sheet 450 along the line direction 124 for each rotation of a work roll or work rolls 410, 411. This value may be based on the circumference of the work rolls 410, 411. Given the rotation speed of the work rolls 410, 411 and the linear displacement of the material sheet 450 per work roll rotation, the control circuit 412 may derive a speed of the material sheet 450.

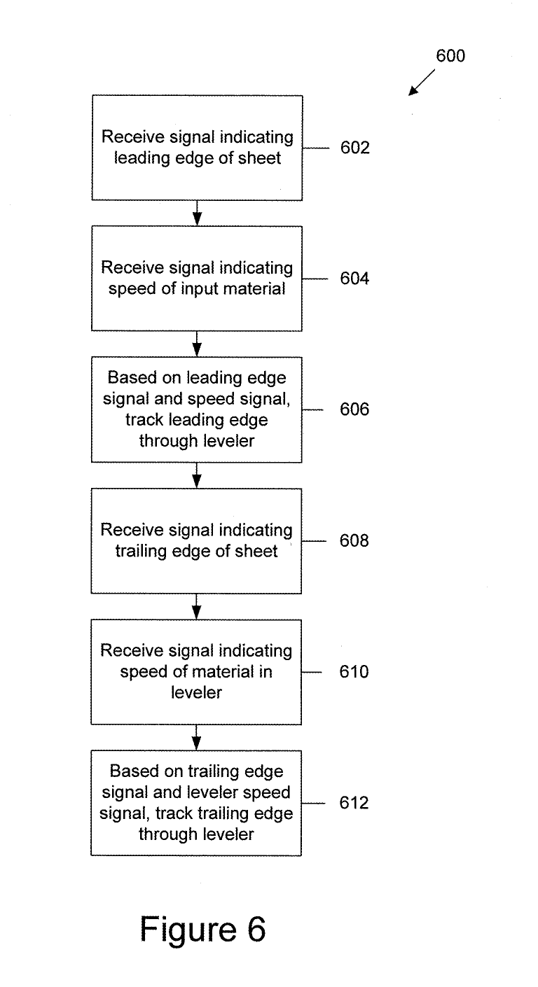

It will be appreciated that the encoder 422 may not provide the correct speed of the material sheet 450 if there is slippage between the material sheet 450 and the work rolls 410, 411. Accordingly, various embodiments may utilize the encoder 422 in conjunction with the proximity sensor and speed sensor 414 to track the position of the material sheet 450. FIG. 6 is a diagram of a process flow 600 illustrating one embodiment of the operation of the control circuit 412 to calculate a position of the material sheet 450 based on signals from the proximity sensor 420, the speed sensor 414 and the encoder 422. At 602, the control circuit 412 may receive a signal indicating the leading edge 421 of the material sheet 450. For example, this signal may be received from the proximity sensor 420 and may occur when the leading edge 421 of the sheet 450 is at about the position of the proximity sensor 420, for example, as shown in FIG. 4.

At 604, the control circuit 412 may receive a second signal indicating a speed of the material sheet 450. For example, the second signal may be received from the material speed sensor 414. At 606, the control circuit 412 may track the leading edge 121 of the material sheet 450 through the leveler 400. For example, the control circuit 412 may utilize the speed received from the material speed sensor 414 over a given interval to find the distance along the line direction 124 traversed by the leading edge 121 during the interval. Given this and the known position of the leading edge 121 at the time of the receipt of the signal from the proximity sensor, the control circuit 412 may periodically and/or continuously derive a position of the leading edge 121. The control circuit 412 may also have access to data indicating the linear position of each of the work rolls 410, 411. From this, the control circuit 412 may derive the number of work rolls 410, 411 in contact with the material sheet 450 and, in some embodiments, may derive the specific work rolls 410, 411 in contact with the material sheet.

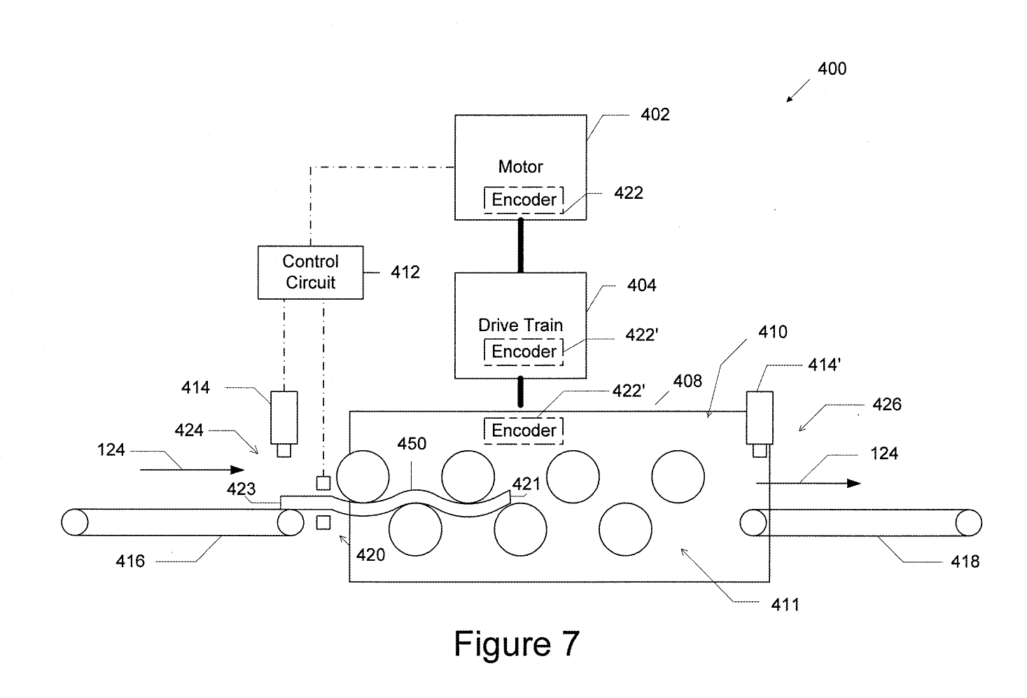

FIG. 7 illustrates a block diagram of the leveler 400 showing the material sheet 450 as it progresses through the leveler 400. As illustrated in FIG. 7, the leading edge 412 has progressed beyond the entry end 424 of the leveler 400 and is engaged by several of the work rolls 410, 411 (e.g., those work rolls are loaded). As the material sheet 450 progressed from the position shown in FIG. 4 to the position shown in FIG. 7, the material speed sensor 414 may have provided the control circuit 414 with an average speed and/or a set of instantaneous speeds. From this, the control circuit 412 may calculate that, since the receipt of the signal from the proximity sensor, the leading edge 421 has traveled a distance d. In some embodiments, the distance traveled may be received directly from the appropriate sensor. (For example, an encoder may provide a signal indicating the passage of a predetermined translational or rotational distance. Counting the number of signals may provide the total distance. Also, for example, some laser velocimeters may also provide an output indicating distance. In some embodiments, distance may be derived from velocity, for example, according to Equation (1) below:

d=speed*time (1)

where d is distance, speed is the material speed (e.g., received from the material speed sensor 414) and time is the time elapsed since receipt of the signal from the proximity sensor 420.

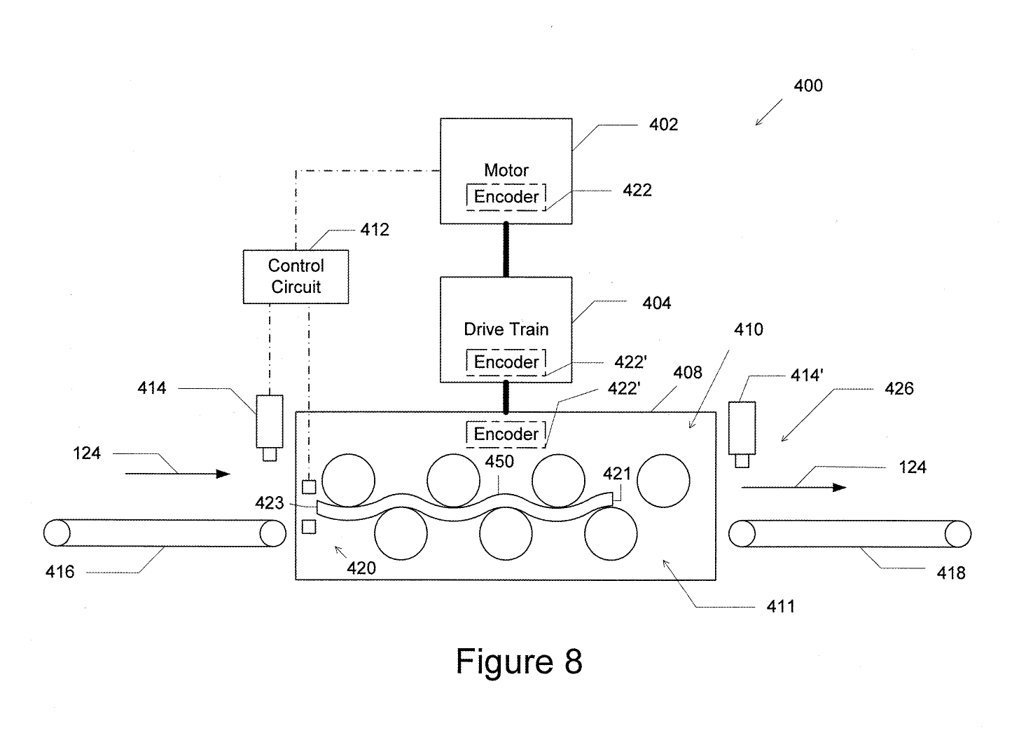

Referring back to FIG. 6, at 608, the control circuit 412 may receive a signal indicating that the trailing edge 423 of the material sheet 450 has reached the proximity sensor 420. For example, the proximity sensor 420 may switch from indicating the presence of material when the trailing edge 423 is at the position of the sensor 420, to indicating that no material is present as the trailing edge 423 passes the sensor 423. FIG. 8 illustrates a block diagram of the leveler 400 showing the material sheet 450 with its trailing edge 423 past the proximity sensor 420. At 610, the control circuit may receive a signal indicating a speed of material in the leveler 400. This signal may be generated by the material speed sensor 414 or the encoder 422. At 612, the control circuit 412 may track the trailing edge 423 of the material sheet 450 based on the signal from the proximity sensor 420 and the indication of sheet 450 speed from the sensor 414 or encoder 422. For example, the control circuit 412 may track the trailing edge 423 of the material sheet 450 in a manner similar to the way that the control circuit 412 may track the leading edge 421, for example, as described herein.

As shown in FIG. 8, when the trailing edge 423 of the material sheet 450 passes the position of the proximity sensor 420, it may no longer be within the field of view of the material speed sensor 414. At this point, the control circuit 412 may calculate the position of the material sheet 450 based on signals received from the encoder 422. The control circuit 412 may switch from calculating position based on the material speed sensor 414 to calculating position based on the encoder 422 according to any suitable method. For example, the control circuit 412 may switch to the encoder 422 when the material sheet 450 has loaded a threshold number of work rolls 410, 411. For example, once the sheet 450 has loaded the threshold number of work rolls 410, 411, it may indicate that the work rolls 410, 411 have traction on the sheet 450 and, therefore, that rotation of the motor 402 may be an accurate indication of the speed of the sheet 450. Also, in various embodiments, the control circuit 412 may have access to data indicating a length of the sheet, allowing the control circuit 412 to estimate a position of the trailing edge 423 before it encounters the sensor 420. When the control circuit 412 determines that the trailing edge 423 is close to exiting the field of view of the material speed sensor 414, it may begin using a signal from the encoder 422 as the indication of material speed.

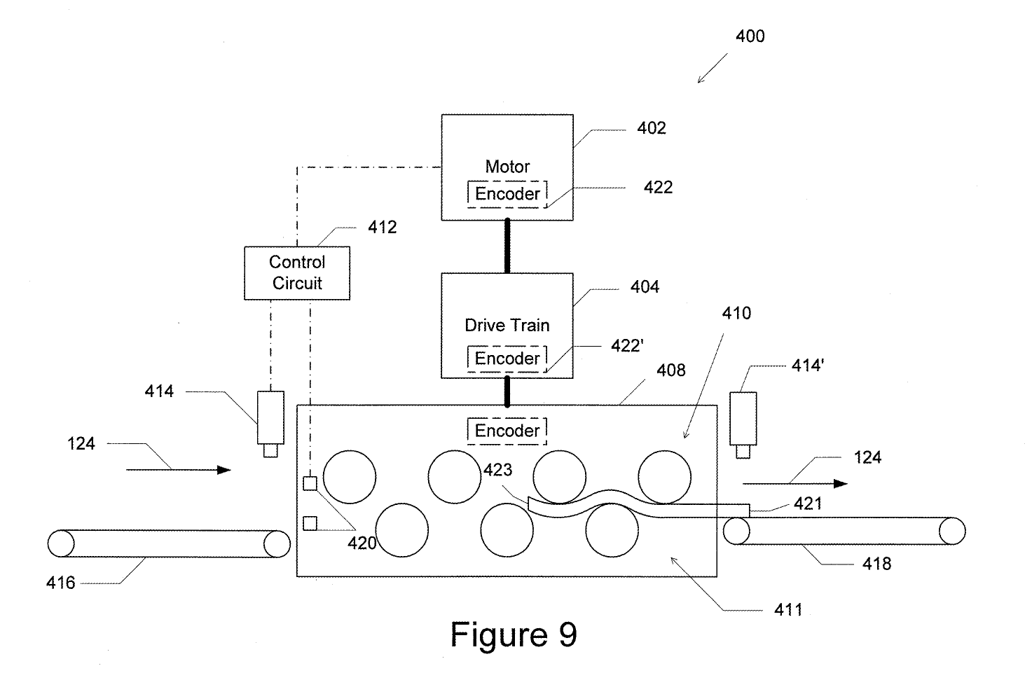

According to various embodiments, the control circuit 412 may also be configured to modulate torque delivered by the motor 402 as the material sheet 450 exits the leveler 400 at the exit end 426. For example, as the trailing edge 423 passes through the leveler 400, work rolls 410, 411 near the entry end 424 may be unloaded. FIG. 9 illustrates a block diagram of one embodiment of the leveler 400 showing unloaded work rolls as the trailing edge 423 of the material sheet 450 passes through the leveler 400, out the exit end and is further moved along the line by the optional exit conveyor 418. By calculating the position of the trailing edge 423, the control circuit 412 may determine either how many work rolls 410, 411 are unloaded or, in some embodiments, the particular work rolls 410, 411 that are unloaded. Torque delivered by the motor 402 may be adjusted accordingly, as described herein.

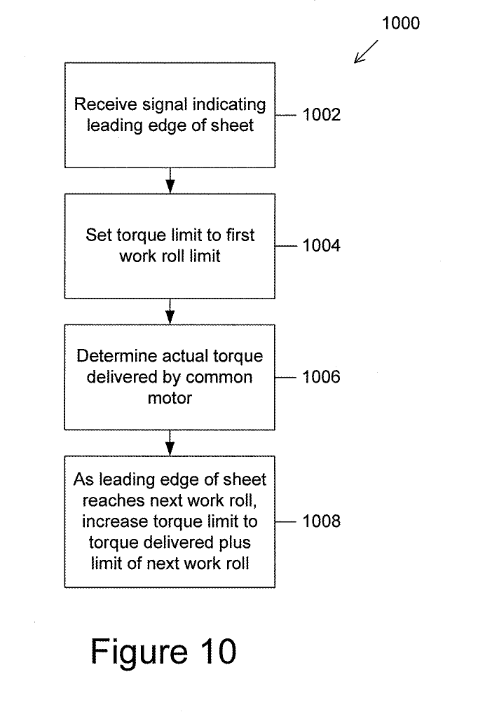

FIG. 10 is a diagram of a process flow 1000 illustrating an alternate embodiment for modulating the torque delivered by the motor 402. According to various embodiments of the process flow 1000, the control circuit 412 may be configured with capabilities for sensing an actual torque delivered by the motor 402 to the work rolls 410, 411 and with capabilities for setting a torque limit for the motor 402. The control circuit 412 may sense the actual torque delivered by the motor 402 in any suitable manner. For example, the actual torque may be measured directly, or derived from another value. In embodiments utilizing a motor drive (e.g., an AC or DC motor drive) the motor drive itself may have an output indicating applied torque (e.g., a torque feedback output). In other embodiments, the control circuit 412 may sample any suitable motor input and/or property indicated actual torque such as, for example, armature current (for DC motors), a torque strain gauge reading (for some AC motors), another motor voltage and/or current reading, etc. In embodiments where the control circuit 412 is digital, the actual torque may be sampled at any suitable rate. The torque limit may represent an upper bound of the torque that the motor 402 may deliver to the leveler 400 (e.g., the work rolls 410, 411) at any given time. The control circuit 412 may enforce the torque limit in any suitable way, for example, as described herein. For example, the control circuit 412 may modulate a current and/or voltage delivered to the motor 402. In embodiments utilizing a drive system, the control circuit 412 may provide the torque limit to the drive system which may enforce the desired torque limit in any suitable manner.

Referring back to the process flow 1000, at 1002, the control circuit 412 may receive a signal indicating a position of the leading edge 421 of the sheet 450 (e.g., from sensor 420). This may indicate that the leading edge 421 is about to contact the first work rolls. Accordingly, at 1004, the control circuit 412 may set a torque limit of the motor 402 to a torque limit of the first work roll (e.g., the first work roll that the sheet 450 will encounter). At various places herein, Applicants refer to the torque limit of a work roll. Such a torque limit may be expressed relative to the work roll itself (e.g., the torque level at which the work roll will fail). In various embodiments, however, the torque limit of a work roll may refer to a torque limit of the work roll and all of the drive train components between the work roll and the motor 402 (e.g., any work roll-related component that may fail due to excessive torque).

At 1006, the control circuit 412 may receive an indication of an actual torque delivered by the motor 402 to the work rolls 410, 411. At 1008, the control circuit 412 may determine that the leading edge 421 of the sheet 450 is about to initiate contact with a work roll, for example, based on the sheet tracking methods described herein. The control circuit 412 may, accordingly, increase the torque limit to an amount roughly equal to the current actual torque delivered by the motor 402 plus a torque threshold of the next work roll to be contacted. In various embodiments, the process flow 1000 may operate in reverse as the sheet 450 exits the leveler 400. For example, as the trailing edge 423 of the sheet 450 loses contact with a work roll, the control circuit 412 may reduce the torque limit for the motor 402 by an amount equivalent to a torque limit for the work roll no longer in contact. Also, in various embodiments, the process flow 1000 may be implemented in conjunction with other methods described herein. For example, as the leading edge 421 of the sheet 450 works it way through the leveler 400, the process flow 1000 may be utilized to increment the torque limit of the motor 402. As the trailing edge 423 of the sheet 450 works through the leveler 400, the torque limit may be set to a multiple of the torque limit for a single work roll, or if the work rolls have individual torque limits, the sum of the torque limits of the work rolls actually in contact with the sheet 450.

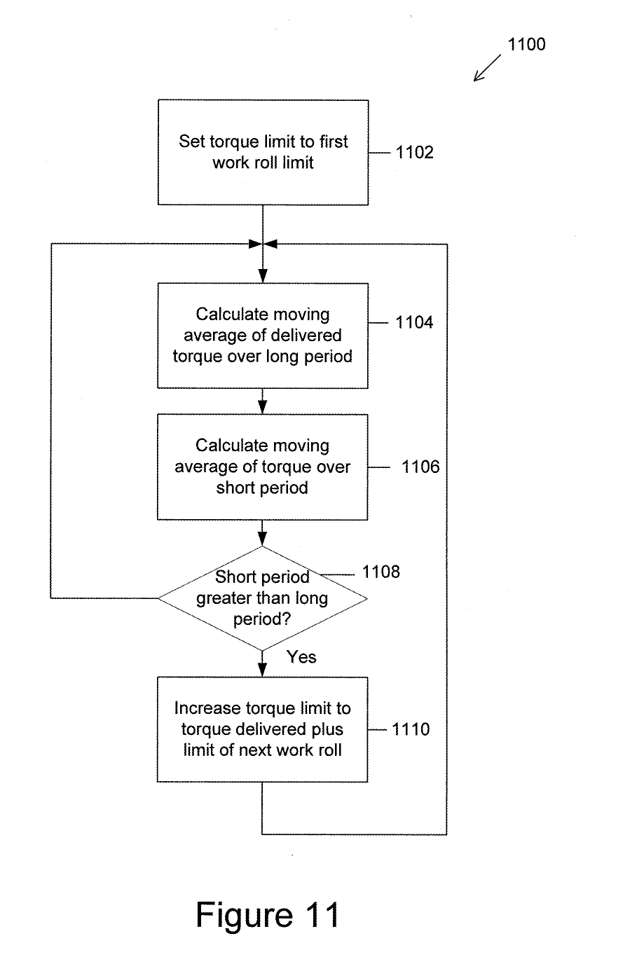

Various other embodiments may operate without the need to track the sheet 450 as it passes through the leveler 400. For example, FIG. 11 is a diagram of a process flow illustrating such an alternate embodiment for modulating the torque delivered by the motor 402. At 1102, when the leveler 400 is empty, the torque limit for the motor 402 may be set (e.g., by the control circuit 412) to a torque limit of the first work roll. As described above, the torque limit for a work roll may be specific to the work roll, or based on design allowances of all work rolls (and related drive train components).

The control circuit 412 may calculate a moving average of the actual torque delivered by the motor 402 over a long period (1104) and a short period (1106). The long and short periods may each represent a fraction of a roll-to-roll time. The roll-to-roll time may represent a time necessary for a portion of the sheet 450 (e.g., the leading edge 421, trailing edge 423, or any other portion of the sheet 450) to travel from one work roll to another. In embodiments where the work rolls 410, 411 are not equally spaced along the line direction 124, different work rolls may have different roll-to-roll times. Accordingly, the lengths of the long period and the short periods (described below) may vary as the leading edge 421 of the sheet 450 travels through the leveler 400. When the leveler 400 is operating at a constant speed, the roll-to-roll time for each set of adjacent work rolls 410, 411 may be constant. For example, the roll-to-roll time may be calculated prior to operation of the leveler 400. In some embodiments, the leveler 400 may operate at a variable speed. In some such embodiments, the leveler 400 (e.g., the control circuit 412) may determine the roll-to-roll time or times based on the current speed of the machine. For example, the distance between each set of adjacent work rolls 410, 411 may be known. The current speed of the sheet 450 may be determined and/or sensed in any suitable manner. For example, the current speed of the sheet 450 may be calculated based on a direction measurement using one or more of sensors 414, 420, 414′, etc., or inferred from a position and/or speed of the motor, 402, the drive train 404 (e.g., as sensed by encoders such as 422, 422′), etc.

The long period of the roll-to-roll time may be a fraction of the roll-to-roll time, for example, greater than ½. In various embodiments, the long period may be ¾ of the roll-to-roll time. The moving average of the long period may represent an expected torque level to be delivered by the motor 402 during steady state (e.g., without encountering any new rolls). The moving average operation may, in various embodiments, represent a low-pass filter for lessening the effects of transients and other noise. The short period may be a fraction of the roll-to-roll time, for example, less than ½. For example, in various embodiments, the short period may represent ⅛ of the roll-to-roll time. The moving average of the short period may represent a filtered version of the currently applied actual torque. Again, the moving average operation may serve to lessen the effects of transients and other noise. In some low-noise embodiments, the moving average over the short period may be replaced by the most recently sampled value for actual torque. Also, in various embodiments, any other suitable noise suppression techniques may be used in addition to or instead of the moving averages described.

At 1108, the control circuit 412 may determine whether the moving average over the short period has exceeded the moving average over the long period. If it has not (e.g., the moving average over the long period is greater than the moving average over the short period, then the control circuit 412 may return to 1104 and 1106 to calculate new moving averages based on any new readings of actual torque. The frequency with which the control circuit 412 executes 1104, 1106 and 1108 may depend, for example, on the sampling period of control circuit 412. For example, in various embodiments, the control circuit 412 may execute 1104, 1106, 1108 once per sampling period.

When the moving average of the short period exceeds the moving average of the long period at 1108, then the control circuit 412 may increase the torque limit to the current actual torque delivered plus a torque limit of the next work roll 410, 411 to be encountered by the leading edge 421 of the sheet 450 (1110). It will be appreciated that when the moving average of the short period exceeds the moving average of the long period, it may indicate an increase in immediate torque delivered by the motor 402 caused, for example, as the leading edge 421 of the sheet 450 contacts the next work roll 410, 411. After the torque limit is raised at 1110 the process may again begin recalculating the moving averages of the long (1104) and short (1106) periods in preparation for the leading edge 421 of the sheet 450 reaching the next work roll. In some embodiments, the control circuit 412 may be further programmed to prevent multiple torque limit increases per work roll. For example, after the torque limit is increased at 1110, the control circuit 412 may implement a timer equal to a large fraction of the roll-to-roll time (e.g., greater than ½, 0.9, etc.). Prior to the timer's expiration, the control circuit 412 may continue to find the moving averages of torque over the long and short periods, but may not update the torque limit. After the expiration of the timer, the process may proceed as described.

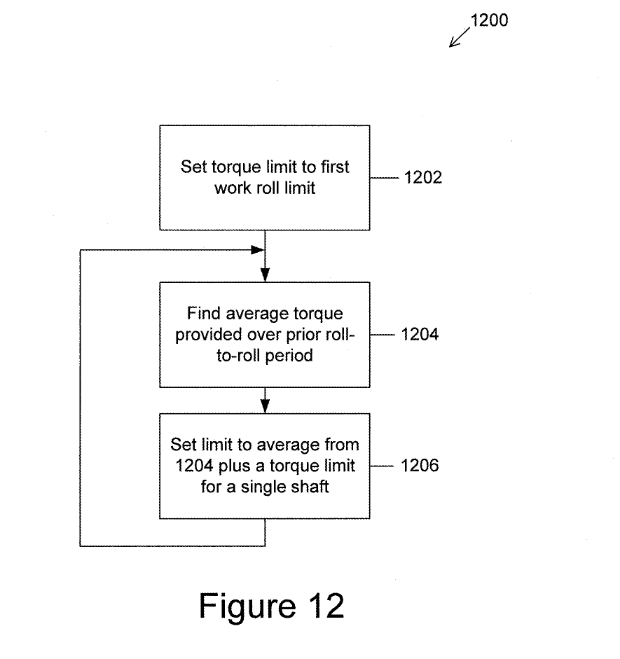

FIG. 12 is a diagram of a process flow 1200 illustrating another embodiment for modulating the torque delivered by the motor 402. At 1200, the control circuit 412 may set the torque limit to a torque limit of the first work roll. At 1204, the control circuit 412 may find a moving average of the actual torque delivered by the motor 402 over a prior period. The prior period may be, for example, greater than ½ of the roll-to-roll time and, in some embodiments, may be set equal to the roll-to-roll time. The moving average operation, for example, may serve as a low-pass filter to remove transients and other noise that might otherwise cause the control circuit 412 to set the torque limit higher or lower than desired. In some embodiments, the moving average operation may be replaced by an analog or digital low-pass filter. At 1206, the control circuit 412 may set the torque limit to the average from 1202 plus a torque limit for a single shaft. In this way, the torque limit may be roughly equal to the current torque being applied plus the limit of one additional work roll (e.g., the next work roll in the line direction 124). In this way, it may not be necessary to track the location of the sheet 450.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. For example, no particular aspect or aspects of the examples of system architectures, methods or processing structures described herein are necessarily intended to limit the scope of the invention.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused descriptions would not facilitate a better understanding of the present invention, and therefore, a more detailed description of such elements is not provided herein.

In various embodiments, modules or software can be used to practice certain aspects of the invention. For example, software-as-a-service (SaaS) models or application service provider (ASP) models may be employed as software application delivery models to communicate software applications to clients (e.g., from a server to the control circuit 412) or other users. Such software applications can be downloaded through an Internet connection, for example, and operated either independently (e.g., downloaded to a laptop or desktop computer system) or through a third-party service provider (e.g., accessed through a third-party web site). In addition, cloud computing techniques may be employed in connection with various embodiments of the invention.

Moreover, the processes associated with the present embodiments may be executed by programmable equipment, such as computers or computer devices. Software or other sets of instructions that may be employed to cause programmable equipment to execute the processes. The processes may be stored in any storage device, such as, for example, a computer (non-volatile) memory, an optical disk, magnetic tape, or magnetic disk. Furthermore, some of the processes may be programmed when the computer is manufactured or via a computer-readable memory medium.

It can also be appreciated that certain process aspects described herein may be performed using instructions stored on a tangible computer-readable memory medium or media that direct a computer or computer system to perform process steps. A tangible computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

A “computer,” “computer device,” “computer system,” “system,” “host,” “engine,” or “processor” may be, for example and without limitation, a processor, programmable logic controller (PLC), microcomputer, minicomputer, server, mainframe, laptop, personal data assistant (PDA), wireless e-mail device, cellular phone, pager, processor, fax machine, scanner, or any other programmable device configured to transmit and/or receive data over a network. Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media.

In various embodiments of the present invention, a single component may be replaced by multiple components, and multiple components may be replaced by a single component, to perform a given function or functions. Except where such substitution would not be operative to practice embodiments of the present invention, such substitution is within the scope of the present invention. Various embodiments of the systems and methods described herein may employ one or more electronic computer networks to promote communication among different components, transfer data, or to share resources and information. For example, the control circuit 412 may be in communication with the various sensors 414, 420, 422 via direct wired or wireless connections and/or via a network, such as a packet-switched network. Such computer networks can be classified according to the hardware and software technology that is used to interconnect the devices in the network, such as optical fiber, Ethernet, wireless LAN, HomePNA, power line communication or G.hn. The computer networks may also be embodied as one or more of the following types of networks: local area network (LAN); metropolitan area network (MAN); wide area network (WAN); virtual private network (VPN); storage area network (SAN); or global area network (GAN), among other network varieties.

While various embodiments of the invention have been described herein, it should be apparent, however, that various modifications, alterations and adaptations to those embodiments may occur to persons skilled in the art with the attainment of some or all of the advantages of the present invention. The disclosed embodiments are therefore intended to include all such modifications, alterations and adaptations without departing from the scope and spirit of the present invention as set forth in the appended claims.

We claim:

1. A torque controlled device for working material, the device comprising:
a plurality of work rolls positioned to work the material, wherein the plurality of work rolls are aligned along a line direction with an entry end for receiving the material and an exit end for providing the worked material, wherein at least a portion of the plurality of work rolls are configured to be driven by a common motor;
a control circuit, wherein the control circuit is programmed to:
calculate a first value indicative of a torque delivered by the common motor to the device; and
set a torque limit for the common motor equal to the first value plus a torque limit increment for an additional work roll selected from the plurality of work rolls.

2. The device of claim 1, wherein the first value is a moving average of actual torque delivered to the device.

3. The device of claim 1, wherein the control circuit is further programmed to derive the first value by applying a low-pass filter to a signal indicating the actual torque delivered by the common motor to the device.

4. The device of claim 1, wherein the additional work roll is a next work roll to be encountered by the material along the line direction.

5. A method of controlling torque delivered to a device for working material, the method comprising:
receiving, by a computer, a first value indicating an actual torque delivered by a common motor of the device to at least a portion of a plurality of work rolls of the device, wherein the plurality of work rolls are driven by the common motor, and wherein the plurality of work rolls are arranged along a line direction aligned with an entry end;
setting, by the computer, a torque limit for the common motor equal to the first value plus a torque limit increment for an additional work roll selected from the plurality of work rolls.

6. The method of claim 5, further comprising filtering the first value before setting the torque limit.

7. The method of claim 5, further comprising modifying the first value to represent a moving average of the actual torque delivered by the common motor over a first period.

8. The method of claim 5, wherein the first period is a roll-to-roll time.

9. A tangible computer readable medium having instructions thereon that, when executed by a computer, cause the computer to:
receive a first value indicating an actual torque delivered by a common motor of a device for working material to at least a portion of a plurality of work rolls of the device, wherein the plurality of work rolls are driven by the common motor, and wherein the plurality of work rolls are arranged along a line direction aligned with an entry end;
set a torque limit for the common motor equal to the first value plus a torque limit increment for an additional work roll selected from the plurality of work rolls.

10. A torque controlled device for working material, the device comprising:
a plurality of work rolls positioned to work the material, wherein the plurality of work rolls are aligned along a line direction with an entry end for receiving the material and an exit end for providing the worked material, wherein at least a portion of the plurality of work rolls are configured to be driven by a common motor;
a control circuit, wherein the control circuit is programmed to:
calculate a first value indicative of an actual torque delivered to the device over a long period;
calculate a second value indicative of an actual torque currently applied to the device; and
when the second value is greater than the first value, set a torque limit for the common motor to the second value plus a torque limit increment for an additional work roll selected from the plurality of work rolls.

11. The device of claim 10, wherein the first value is a moving average of the actual torque applied to the work rolls over the long period.

12. The device of claim 11, wherein the second value is a moving average of the actual torque applied to the work rolls over the short period, wherein the short period is less than the long period.

13. The device of claim 12, wherein the long period is greater than ½ of a roll-to-roll time and wherein the short period is less than ½ of the roll-to-roll time.

14. The device of claim 13, wherein long period is equal to ¾ of the roll-to-roll time and the short period is equal to ⅛ of the roll-to-roll time.

15. The device of claim 10, wherein the material is formed as at least one of a sheet or a web.

16. The device of claim 10, wherein the material is selected from the group consisting of carbon steel, stainless steel, copper, brass, aluminum, titanium, and plastic.

17. The device of claim 10, wherein the control circuit is further programmed to initially set the torque limit for the common motor to a torque limit increment for a first work roll along the line direction.

18. A method of controlling torque delivered to a device for working material, the method comprising:
receiving, by a computer, a value indicating an actual torque delivered by a common motor of the device to at least a portion of a plurality of work rolls of the device, wherein the plurality of work rolls are driven by the common motor, and wherein the plurality of work rolls are arranged along a line direction aligned with an entry end;
calculating a first value indicative of an actual torque delivered to the device over a long period;
calculating a second value indicative of an actual torque currently applied to the device; and
when the second value is greater than the first value, set a torque limit for the common motor equal to the second value plus a torque limit increment for an additional work roll selected from the plurality of work rolls.

19. A tangible computer readable medium having instructions thereon that, when executed by a computer, cause the computer to:
receive a value indicating an actual torque delivered by a common motor of a device for working material to at least a portion of a plurality of work rolls of the device, wherein the plurality of work rolls are driven by the common motor, and wherein the plurality of work rolls are arranged along a line direction aligned with an entry end;
calculate a first value indicative of an actual torque delivered to the device over a long period;
calculate a second value indicative of an actual torque currently applied to the device; and
when the second value is greater than the first value, set a torque limit for the common motor equal to the second value plus a torque limit increment for an additional work roll selected from the plurality of work rolls.

20. A torque controlled device for working material, the device comprising:
a plurality of work rolls positioned to work the material, wherein the plurality of work rolls are aligned along a line direction with an entry end for receiving the material and an exit end for providing the worked material, wherein at least a portion of the plurality of work rolls are configured to be driven by a common motor;
at least one sensor positioned to sense data indicating a position of the material along the line direction between the work rolls;
a control circuit, wherein the control circuit is programmed to:
calculate the position of the material along the line direction between the work rolls;
determine a quantity of work rolls in contact with the material based on the position of the material;
calculate a torque limit indicating a maximum torque to be delivered to the plurality of work rolls considering the quantity of work rolls in contact with the material; and
regulate a torque delivered to the work rolls by the common motor based on the torque limit.

21. The device of claim 20, wherein the at least one sensor comprises:
a material speed sensor positioned to sense a speed of the material at about the entry end of the plurality of work rolls; and
a proximity sensor positioned to sense a leading edge of the material at about the entry end of the plurality of work rolls.

22. The device of claim 21, wherein the material speed sensor is a laser Doppler velocimeter.

23. The device of claim 20, wherein the at least one sensor comprises an encoder in mechanical communication with at least one of component selected from the group consisting of a work roll selected from the plurality of work rolls and the common motor.

24. The device of claim 20, wherein calculating the desired torque to be delivered to the plurality of work rolls comprises:
receiving a per-work roll torque limit; and
multiplying the per-work roll torque limit by the quantity of work rolls in contact with the material.

25. The device of claim 20, wherein calculating the desired torque to be delivered to the plurality of work rolls comprises:
determining an identity of each of the plurality of work rolls in contact with the material;
receiving a torque limit for each of the work rolls in contact with the material; and
summing the torque limits for each of the work rolls in contact with the material.

26. The device of claim 20, wherein calculating the position of the material along the line direction between the work rolls comprises:
receiving, at a first time, an indication of a leading edge of the material from a sensor at a first position along the line direction;
receiving, from a material speed sensor, a first indication of a speed of the material in the line direction;
calculating the position of the material considering the first time and the first indication of the speed.

27. The device of claim 26, wherein calculating the position of the material along the line direction between the work rolls further comprises:
receiving, from an encoder, a second indication of the speed of the material in the line direction;
upon determining that a threshold number of the plurality of work rolls are in contact with the material, calculating the position of the material considering the first time and the second indication of the speed.

28. The device of claim 26, wherein calculating the position of the material along the line direction between the work rolls comprises calculating a position of a leading edge of the material.

29. The device of claim 26, wherein calculating the position of the material along the line direction between the work rolls comprises calculating a position of a trailing edge of the material.

30. The device of claim 20, wherein the control circuit is further programmed to receive a value indicative of an actual torque delivered to the plurality of work rolls, and, when the calculated position of the material along the line direction indicates that a leading edge of the material is proximate a next work roll, increase the desired torque by a torque limit of the next work roll.

31. A method of controlling torque delivered to a device for working material, the method comprising:
receiving, by a computer, a first signal indicating a presence of a leading edge of the material at an entry end of the device, wherein the entry end is aligned with a plurality of work rolls of the device along a line direction, wherein the plurality of work rolls are driven by a common motor;
receiving, by the computer, a second signal indicating a velocity of the material along the line direction;
calculating, by the computer, a position of the material considering the first signal and the second signal;
calculating, by the computer, an indication of work rolls from the plurality of work rolls that are in contact with the material based on the position of the material;
calculating, by the computer, a torque limit indicating a maximum torque to be delivered to the plurality of work rolls considering the quantity of work rolls in contact with the material; and
regulating, by the computer, a torque delivered to the work rolls by the common motor based on the torque limit.

32. A tangible computer readable storage medium comprising instructions thereon that, when executed by a computer, cause the computer to:
receive a first signal indicating a presence of a leading edge of the material at an entry end of a device for working material, wherein the entry end is aligned with a plurality of work rolls of the device along a line direction, wherein the plurality of work rolls are driven by a common motor;
receive a second signal indicating a velocity of the material along the line direction;
calculate a position of the material considering the first signal and the second signal;
calculate an indication of work rolls from the plurality of work rolls that are in contact with the material based on the position of the material;
calculate a torque limit indicating a maximum torque to be delivered to the plurality of work rolls considering the quantity of work rolls in contact with the material; and
regulate a torque delivered to the work rolls by the common motor based on the torque limit.
